(19) United States
(12) Patent Application Publication
(10) Pub. No.: US 2026/0301388 A1
(43) Pub. Date: Oct. 1, 2026

(54) DETECTION DEVICE, DETECTING METHOD AND NON-TRANSITORY COMPUTER-READABLE MEDIUM FOR OBJECT DETECTION

(71) Applicant: LITE-ON TECHNOLOGY CORPORATION, Taipei (TW)

(72) Inventors: Hsuan-Ta LIN, Taipei (TW); Chi-Cheng LIAU, Taipei (TW); Tse-Chun WANG, Taipei (TW)

(21) Appl. No.: 19/435,830

(22) Filed: Dec. 30, 2025

Related U.S. Application Data
(60) Provisional application No. 63/779,428, filed on Mar. 28, 2025.

(30) Foreign Application Priority Data
Nov. 13, 2025 (CN) 202511660761.4

(51) Int. Cl. G06V 10/776; G06V 10/762; G06V 10/764; G06V 20/58

(52) U.S. Cl. CPC G06V 10/776; G06V 10/762; G06V 10/764; G06V 20/58

(57) ABSTRACT

A detection device is provided for object detection in an image data processing system. A first computational model detects several objects of different categories in a validation set to generate a detection result. An index analysis circuit analyzes the detection result to generate a highest index score of each category. A clustering circuit clusters the categories into several clusters based on the highest index scores and selects a second number of clusters from the first number of clusters. A normalization calculation circuit calculates an object amount ratio and an average area ratio of the categories in selected clusters. A global calculation circuit calculates a global confidence threshold based on the object amount ratio and the average area ratio. The first computational model detects objects in first images from an image data metadata of image data processing system in an inference stage, filtering inference results based on global confidence threshold.

This application claims the benefit of U.S. provisional application Ser. No. 63/779,428, filed Mar. 28, 2025, and CN application No. 202511660761.4, filed Nov. 13, 2025, the disclosure of which is incorporated by reference herein in its entirety.

### TECHNICAL FIELD

The present disclosure relates to a detection mechanism, and more particularly relates to a detection device and a method for detecting different categories of objects in images.

### BACKGROUND

In applications such as autonomous driving, security monitoring and activity recognition, computational models can be used to detect objects, marking and classifying their positions in images. Furthermore, a confidence threshold can be set in the computational model to filter out detection results with poor performance. For example, when the computational model detects an object, it assigns a confidence score, representing the model's confidence level in the detection result. Detection results with confidence scores below the confidence threshold are filtered out, so as to reduce false alarms and improve overall detection accuracy.

In the operation of traditional computational model for object detection, the confidence threshold is manually adjusted, so as to set a screening threshold for candidate frames. However, when the number of samples in the test set of the computational model is insufficient, the manually adjusted screening threshold for candidate frames cannot reach the optimal value, and cannot simultaneously detect different categories of objects. The confidence threshold for categories with poor detection performance may cause overall misjudgment of the computational model.

To address the above issues, an improved detection mechanism is needed, which can dynamically adjust the confidence threshold of the computational model, so as to obtain the globally optimized confidence threshold, thereby improving the detection accuracy of the computational model for different categories of objects.

### SUMMARY

According to one embodiment of the present disclosure, a detection device is provided, which is applied to object detection in an image data processing system. The detection device includes a first computational model, an index analysis circuit, a clustering circuit, a normalization calculation circuit, and a global calculation circuit. The first computational model detects a plurality of objects in a validation set during the validation phase to generate detection results, wherein the objects have a plurality of categories. The index analysis circuit is communicatively connected to the first computational model and analyzes the detection results of the first computational model to generate the highest index score for each category. The clustering circuit is electrically connected to the index analysis circuit and clusters the categories into a first number of plurality of clusters based on the highest index score of each category, and selects a second number of plurality of clusters from the first number of clusters. The normalization calculation circuit is electrically connected to the clustering circuit and performs normalization calculation to obtain the object amount ratio and average area ratio of each category in the second number of clusters. The global calculation circuit is electrically connected to the normalization calculation circuit and calculates a global confidence threshold based on the object amount ratio and average area ratio of each category. A first computational model receives a plurality of first images from the image data metadata of an image data processing system. During the inference phase, it detects objects in the first images to generate inference results and filters the inference results based on a global confidence threshold.

According to another embodiment of the present disclosure, a detection method is provided, applied to object detection in an image data processing system. The detection method includes the following steps. In the validation phase of the first computational model, a plurality of objects in a validation set are detected by the first computational model to generate detection results, wherein the objects have a plurality of categories. The detection results of the first computational model are analyzed to generate the highest index score for each category. Based on the highest index score of each category, the categories are clustered into a first number of plurality of clusters. A second number of plurality of clusters are selected from the first number of clusters. Regularization calculations are performed to obtain the object amount ratio and average area ratio of each category in the second number of clusters. A global confidence threshold is calculated based on the object amount ratio and average area ratio of each category. A plurality of first images from the image data metadata of an image data processing system are received by the first computational model. In the inference phase of the first computational model, objects in the first image are detected using the first computational model to generate an inference result. The inference result is filtered based on a global confidence threshold.

According to still another embodiment of the present disclosure, a non-volatile computer-readable storage medium is provided, which is applied in a computing device or a computer and stores instructions to execute the detection method provided in the present disclosure.

### BRIEF DESCRIPTION OF THE DRAWINGS

FIG. 1 is a block diagram of a detection device 1000 according to an embodiment of the present disclosure.

FIG. 2 is a curve graph which shows the correspondence between the index score F1 and the confidence level CL.

FIG. 3 is a schematic diagram of the detection device 1000 of FIG. 1 applied to an image data processing system 2000.

FIG. 4 is a flowchart of a detection method according to an embodiment of the present disclosure.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

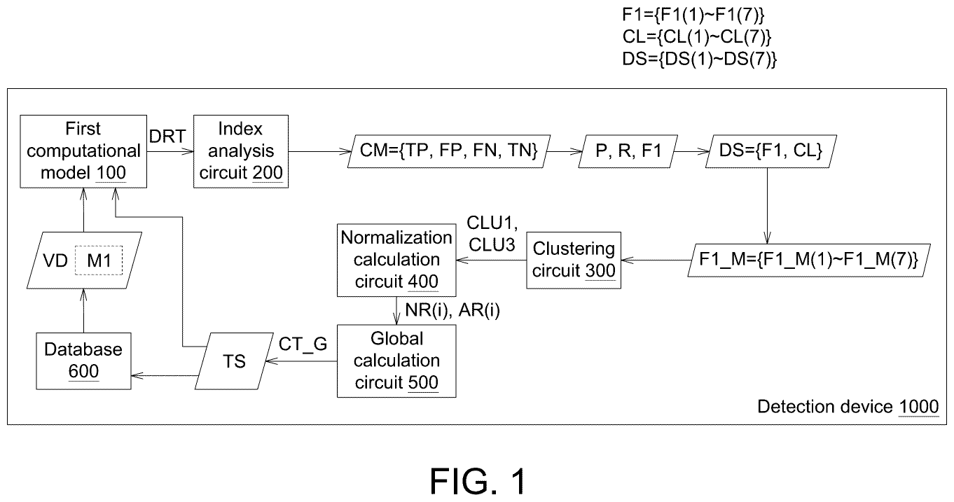

FIG. 1 is a block diagram of a detection device 1000 according to an embodiment of the present disclosure. The detection device 1000 is used for object detection. In one example, the detection device 1000 may be installed on a moving vehicle to detect multiple objects in the surrounding environment.

The objects to be detected may be, for example, vehicles, drivers or pedestrians on the road ahead of the moving vehicle. As shown in FIG. 1, the detection device 1000 includes a first computational model 100, an index analysis circuit 200, a clustering circuit 300, a normalization calculation circuit 400, a global calculation circuit 500 and a database 600. The first computational model 100 is communicatively connected to the database 600 and the index analysis circuit 200. The clustering circuit 300 is electrically connected to the index analysis circuit 200 and the normalization calculation circuit 400. The global calculation circuit 500 is electrically connected to the database 600 and the normalization calculation circuit 400.

Specifically, the modules and circuits in the detection device 1000 can be implemented by software, hardware or firmware. If implemented by hardware, it can be a processing unit, a processor, a computer or a server with data processing and computing capabilities. If implemented by software or firmware, it can include instructions executable by the processing unit, the processor, the computer or the server, and can be installed on the same hardware device or distributed across multiple hardware devices. In other words, the modules and circuits in the detection device 1000 can be implemented by one or more processors, microcontrollers, digital signal processors or the executed program codes, and are not limited to circuits with physical layout. Furthermore, the database 600 in the detection device 1000 includes hard drives (such as mechanical hard drives, solid-state drives, etc.), memory, other storage devices, or combinations of these devices.

During a validation phase of the first computational model 100, the first computational model 100 receives a validation set VD from the database 600, and performs validation based on multiple validation images M1 of the validation set VD. The first computational model 100 detects (i.e., predicts) objects to be detected in the validation image M1, so as to achieve object detection and generates a detection result DRT. The objects to be detected can be classified into N categories, for example, seven categories which include: the first category “RV”, the second category “truck”, the third category “bus”, the fourth category “pedestrian”, the fifth category “rider”, the sixth category “motorcycle”, and the seventh category “bicycle”.

The index analysis circuit 200 receives the detection result DRT from the first computational model 100 and analyzes the detection result DRT to generate an index score F1. The index score F1 represents the detection performance of the first computational model 100 for each category of objects. For example, the index score F1(1) represents the detection performance of the first computational model 100 in the detection result DRT for the first category “RV”, and the index score F1(2) represents the detection performance of the first computational model 100 in the detection result DRT for the second category “truck”. Similarly, the index scores F1(3), F1(4), F1(5), F1(6) and F1(7) represent the detection performance of the first computational model 100 in the detection results DRT for the third category “bus”, the fourth category “pedestrian”, the fifth category “rider”, the sixth category “motorcycle” and the seventh category “bicycle”, respectively.

More specifically, the index analysis circuit 200 analyzes the detection results DRT of the first computational model 100 using a hardware image processor (not shown in the figure) to obtain a confusion matrix CM associated with the detection result DRT. The confusion matrix CM has four elements, including an element TP, an element FP, an element FN, and an element TN. The element TP indicates that the detection result DRT of the first computational model 100 is “object present” and an object exists in the real environment. The element FP indicates that the detection result DRT of the first computational model 100 is “object present” but no object exists in the real environment. On the other hand, the element FN indicates that the detection result DRT of the first computational model 100 is “object absent” but an object exists in the real environment. The element TN indicates that the detection result DRT of the first computational model 100 is “object absent” and no object exists in the real environment.

Based on elements TP, FP, FN and TN of the confusion matrix CM, the index analysis circuit 200 can further calculate a precision index P and a recall index R, as shown in equations (1-1) and (1-2). Wherein, the precision index P indicates the proportion of samples in the real environment which are actually “positive”, among all samples for the detection result DRT of the first computational model 100 which is “positive”. The recall index R indicates the proportion of samples for the detection result DRT of the first computational model 100 which is “positive”, among all samples in the real environment which are actually “positive”.

$$P = \frac{TP}{TP + FP} \qquad ( 1 - 1 )$$

$$R = \frac{TP}{TP + FN} \qquad ( 1 - 2 )$$

Furthermore, based on the precision index P and the recall index R, the index analysis circuit 200 calculates the index score F1 using hardware adder/subtractor circuits and multiplier/divider circuits (not shown in the figure), as shown in equation (1-3). The index score F1 is a comprehensive index score of the precision index P and the recall index R; therefore, the index score F1 can comprehensively represent the detection performance of the first computational model 100 for each category of objects.

$$F 1 = \frac{P \times R}{P + R} \times 2 \qquad ( 1 - 3 )$$

In addition, the detection result DRT of the first computational model 100 has a confidence level CL. The higher the confidence level CL is, the higher the accuracy of the detection result DRT can be achieved. Different values of the index score F1 correspond to different values of the confidence level CL, and the correspondence between the index score F1 and the confidence level CL can be represented by a curve. Furthermore, the correspondence between the index score F1 and the confidence level CL forms a data sequence DS.

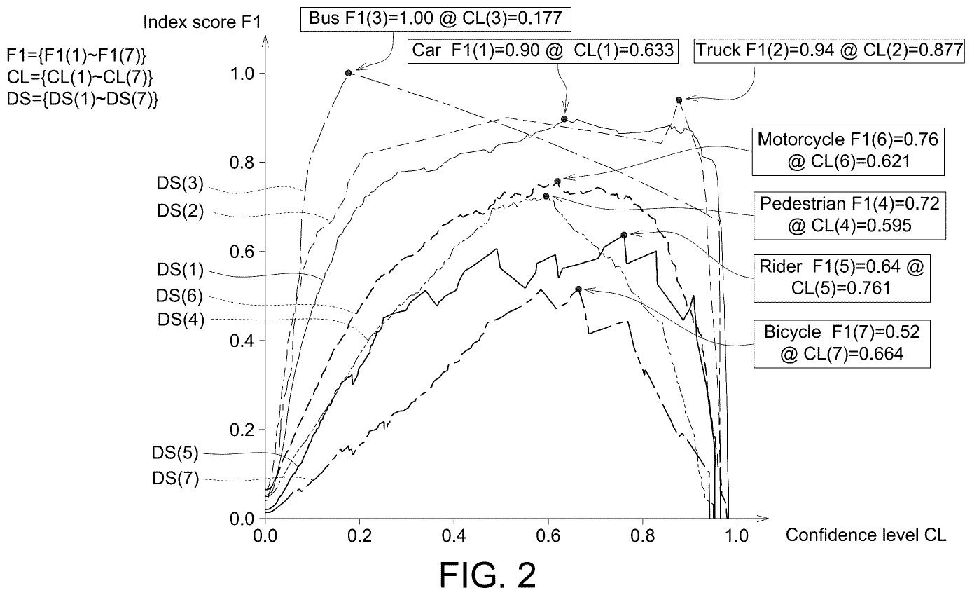

Please refer to FIG. 2, which is a curve graph showing the correspondence between the index score F1 and the confidence level CL. The correspondence between the index score F1(1) and the confidence level CL(1) for the first category “RV” in the detection results DRT of the first computational model 100 forms a data sequence DS(1), which is presented as a curve. The range of both the index score F1(1) and the confidence level CL(1) is between the values “0.0” and “1.0”. Similarly, the correspondence between the index score F1(2) and the confidence level CL(2) for the second category “Truck” in the detection results DRT of the first computational model 100 forms a data sequence DS(2). And so on, the respective correspondences between the index scores F1(3)~F1(7) for the third to seventh categories and their corresponding confidence levels CL(3)~CL(7) in the detection results DRT of the first computational model 100 respectively form data sequences DS(3)~DS(7).

The index analysis circuit 200 analyzes the data sequences DS(1) to DS(7) of various categories of objects to obtain the highest values of the index scores F1(1) to F1(7) for these categories. For example, the index analysis circuit 200 performs a “grid search” on the data sequences DS(1) to DS(7) using a hardware comparator circuit (not shown in the figure) to obtain the highest index scores F1_M(1) to F1_M(7) for these categories. Due to the advantages of the “grid search” algorithm, the highest index score(s) and corresponding confidence level(s) can be obtained in the validation set VD or test set TS. The search result of the “grid search” algorithm is closer to the maximum detection performance of the first computational model 100.

Furthermore, the index analysis circuit 200 analyzes the values of the confidence levels CL(1) to CL(7) corresponding to the highest index scores F1_M(1) to F1_M(7). For example, the index analysis circuit 200 analyzes the highest index score F1_M(1) “0.90” for the first category “RV” and its corresponding confidence level CL(1) “0.633”. Similarly, the index analysis circuit 200 analyzes the following results: the highest index score F1_M(2) “0.94” for the second category “truck” and its corresponding confidence level CL(2) “0.877”, the highest index score F1_M(3) “1.00” for the third category “bus” and its corresponding confidence level CL(3) “0.177”, and the highest index score F1_M(4) “0.72” for the fourth category “pedestrian” and its corresponding confidence level CL(4) “0.595”, the highest index score F1_M(5) “0.64” for the fifth category “rider” and its corresponding confidence level CL(5) “0.761”, the highest index score F1_M(6) “0.76” for the sixth category “motorcycle” and its corresponding confidence level CL(6) “0.621”, and the highest index score F1_M(7) “0.52” for the seventh category “bicycle” and its corresponding confidence level CL(7) “0.664”. The above analysis results are shown in Table 1:

TABLE 1

| | first | second | third | fourth | fifth | sixth | seventh |
|---|---|---|---|---|---|---|---|
| Category | category | category | category | category | category | category | category |
| Object | RV | Truck | Bus | Pedestrian | Rider | Motorcycle | Bicycle |
| Highest | 0.90 | 0.94 | 1.00 | 0.72 | 0.64 | 0.76 | 0.52 |
| index score | | | | | | | |
| F1_M | | | | | | | |
| Confidence | 0.633 | 0.877 | 0.177 | 0.595 | 0.761 | 0.621 | 0.664 |
| level CL | | | | | | | |

Please refer to FIG. 1 again, the index analysis circuit 200 provides the highest index scores F1_M(1) to F1_M(7) of the seven categories to the clustering circuit 300 for clustering processing. In this embodiment, the clustering circuit 300 can perform “K-means” clustering based on the highest index scores F1_M(1) to F1_M(7), so as to divide the seven categories of the object to be detected into K clusters. For example, if K equals “3”, the clustering circuit 300 divides the seven categories into three clusters.

“K-means” clustering includes multiple iterations. First, in the first iteration of clustering, the clustering circuit 300 randomly sets K initial center points (e.g., K equals “3”). For example, the clustering circuit 300 randomly setting the first center point to “0.8”, the second center point to “0.4” and the third center point to “0.2”, as shown in Table 2-1:

TABLE 2-1
First iteration

| Center | First center | Second center | Third center |
|---|---|---|---|
| point | point | point | point |
| Value of | 0.8 | 0.4 | 0.2 |
| center point | | | |

Next, the clustering circuit 300 calculates the respective distances between the highest index scores F1_M(1) to F1_M(7) of the seven categories and the three initial center points, using a hardware addition/subtraction circuit (not shown in the figure). The clustering circuit 300 calculates a distance “0.1” between the highest index score F1_M(1) “0.90” of the first category “RV” and the first center point “0.8”, a distance “0.5” between the highest index score F1_M(1) “0.90” of the first category “RV” and the second center point “0.4”, and a distance “0.7” between the highest index score F1_M(1) “0.90” of the first category “RV” and the third center point “0.2”.

Similarly, the clustering circuit 300 calculates a distance “0.14” between the highest index score F1_M(2) “0.94” of the second category “truck” and the first center point “0.8”, a distance “0.54” between the highest index score F1_M(2) “0.94” of the second category “truck” and the second center point “0.4”, and a distance “0.74” between the highest index score F1_M(2) “0.94” of the second category “truck” and the third center point “0.2”.

Likewise, the clustering circuit 300 calculates the respective distances between the highest index scores F1_M(3) to F1_M(7) of the other five categories and the first center point “0.8”, the second center point “0.4” and the third center point “0.2”. The calculation results of the above distances are shown in Table 2-2:

TABLE 2-2
First iteration

| | | | Distance | | |
|---|---|---|---|---|---|
| | | Distance | from | Distance | |
| | Highest | from first | second | from third | |
| | index | center | center | center | |
| | score | point | point | point | Clustering |
| category | F1_M | “0.8” | “0.4” | “0.2” | results |
| first | 0.90 | 0.1 | 0.5 | 0.7 | first cluster |
| category | | | | | CLU1 |
| second | 0.94 | 0.14 | 0.54 | 0.74 | third cluster |
| category | | | | | CLU3 |
| third | 1.00 | 0.2 | 0.6 | 0.8 | third cluster |
| category | | | | | CLU3 |
| fourth | 0.72 | 0.08 | 0.32 | 0.52 | first cluster |
| category | | | | | CLU1 |
| fifth | 0.64 | 0.16 | 0.24 | 0.44 | second cluster |
| category | | | | | CLU2 |
| sixth | 0.76 | 0.04 | 0.36 | 0.56 | first cluster |
| category | | | | | CLU1 |
| seventh | 0.52 | 0.28 | 0.12 | 0.32 | second cluster |
| category | | | | | CLU2 |

Then, the clustering circuit 300 clusters the seven categories into three clusters based on the distances between the highest index scores F1_M(1) to F1_M(7) of these categories and the three center points. The clustering circuit 300 uses a hardware comparator circuit (not shown in the figure) to compare the distances between the highest index scores F1_M(1) to F1_M(7) of the categories and the three center points, clustering the categories closest to a particular center point into the same cluster.

For example, the highest index score F1_M(1) “0.90” of the first category, the highest index score F1_M(4) “0.72” of the fourth category, and the highest index score F1_M(6) “0.76” of the sixth category are closest to the first center point “0.8”. Therefore, the first, fourth and sixth categories are clustered into the same first cluster CLU1. In addition, the highest index score F1_M(5) “0.64” of the fifth category and the highest index score F1_M(7) “0.52” of the seventh category are closest to the second center point “0.4”. Therefore, the fifth and seventh categories are clustered into the same second cluster CLU2. Furthermore, although the highest index scores F1_M(1) and F1_M(4) to F1_M(7) of the first category and the fourth to seventh categories are relatively close to the third center point “0.2”, the first category and the fourth to seventh categories have already been clustered into the first cluster CLU1 or the second cluster CLU2. Therefore, the remaining second category and third category are clustered into the third cluster CLU3.

The above examples describe clustering process of the first iteration performed by the clustering circuit 300. The clustering results obtained from the first iteration are as follows: the first category “RV”, the fourth category “pedestrian” and the sixth category “motorcycle” are clustered into the first cluster CLU1. The fifth category “rider” and the seventh category “bicycle” are clustered into the second cluster CLU2. The second category “truck” and the third category “bus” are clustered into the third cluster CLU3.

Then, the second iteration of clustering process is performed. Firstly, the three center points are updated: the clustering circuit 300 calculates the average of the highest index scores F1_M for the categories within the same cluster after the first iteration of clustering, and uses this average of the highest index scores F1_M as the value of the updated center point. For example, the first cluster CLU1 of the first iteration of clustering result includes the first, fourth and sixth categories. The average of the highest index score F1_M(1) “0.90”, F1_M(4) “0.72” and F1_M(6) “0.76” for the above three categories is “0.793”. This average “0.793” is used as the value of the updated first center point. Similarly, the second cluster CLU2 of the first iteration of clustering result includes the fifth and seventh categories. The average of the highest index scores F1_M(5) “0.64” and F1_M(7) “0.52” for these two categories is “0.58”. This average “0.58” is used as the value of the updated second center point. Furthermore, the third cluster CLU3 of the first iteration of clustering result includes the second and third categories. The average of the highest index scores F1_M(2) “0.74” and F1_M(3) “0.8” for these two categories is “0.77”. This average “0.77” is used as the value of the updated third center point.

The updated first center point “0.793”, the updated second center point “0.58”, and the updated third center point “0.77” will be used as the three center points for the second iteration of clustering process, as shown in Table 3-1:

TABLE 3-1
Second iteration

| Center | First center | Second center | Third center |
|---|---|---|---|
| point | point | point | point |
| Value of | 0.793 | 0.58 | 0.77 |
| center point | | | |

Then, the clustering circuit 300 repeats corresponding steps of the first iteration: calculating the distances between the highest index scores F1_M(1) to F1_M(7) of the seven categories and the updated first center point “0.793”, the updated second center point “0.58” and the updated third center point “0.77”, as shown in Table 3-2:

TABLE 3-2
Secon iteration

| | | | Distance | | |
|---|---|---|---|---|---|
| | | Distance | from | Distance | |
| | Highest | from first | second | from third | |
| | index | center | center | center | |
| | score | point | point | point | Clustering |
| category | F1_M | “0.793 | “0.58” | “0.77” | results |
| first | 0.90 | 0.107 | 0.32 | 0.13 | first cluster |
| category | | | | | CLU1 |
| second | 0.94 | 0.147 | 0.36 | 0.17 | first cluster |
| category | | | | | CLU1 |
| third | 1.00 | 0.207 | 0.42 | 0.23 | first cluster |
| category | | | | | CLU1 |
| fourth | 0.72 | 0.073 | 0.14 | 0.05 | third cluster |
| category | | | | | CLU3 |
| fifth | 0.64 | 0.153 | 0.06 | 0.13 | second cluster |
| category | | | | | CLU2 |
| sixth | 0.76 | 0.033 | 0.18 | 0.01 | third cluster |
| category | | | | | CLU3 |
| seventh | 0.52 | 0.273 | 0.06 | 0.25 | second cluster |
| category | | | | | CLU2 |

Then, the clustering circuit 300 re-clusters the seven categories based on the distances between the highest index scores F1_M(1) to F1_M(7) of the seven categories and the updated three center points. Similar to the clustering mechanism of the first iteration, the categories with highest index scores F1_M(1) to F1_M(7) among the seven categories, which are closest to the updated three center points, are clustered into the same cluster. The highest index score F1_M(1) “0.90” of the first category, the highest index score F1_M(2) “0.94” of the second category, and the highest index score F1_M(3) “1.00” of the third category are closest to the updated first center point “0.793”; therefore, the first category, the second category and the third category are re-clustered into the first cluster CLU1. Furthermore, the highest index score F1_M(5) “0.64” for the fifth category and the highest index score F1_M(7) “0.52” for the seventh category are closest to the updated second center point “0.58”; therefore, the fifth and seventh categories are still clustered into the second cluster CLU2. Moreover, the highest index score F1_M(4) “0.72” for the fourth category and the highest index score F1_M(6) “0.76” for the sixth category are closest to the updated third center point “0.77”; therefore, the fourth and sixth categories are re-clustered into the third cluster CLU3.

The clustering results of the second iteration are as follows: the first category “RV”, the second category “truck” and the third category “bus” are clustered into the first cluster CLU1. The fifth category “rider” and the seventh category “bicycle” are clustered into the second cluster CLU2. The fourth category “pedestrian” and the sixth category “motorcycle” are clustered into the third cluster CLU3.

Subsequently, the clustering circuit 300 performs a third iteration of clustering processing based on the same mechanism. The three center points are updated again using the average of the highest index scores F1_M of the categories within the same cluster from the clustering results of second iteration. For example, the average “0.946” of the highest index scores F1_M(1), F1_M(2) and F1_M(3) for the first, second and third categories included in the first cluster CLU1, is used as the value of the updated first center point. Furthermore, the average “0.74” of the highest index scores F1_M(4) and F1_M(6) for the fourth and sixth categories included in the third cluster CLU3 is used as the value of the updated third center point.

On the other hand, the average “0.58” of the highest index scores F1_M(5) and F1_M(7) for the fifth and seventh categories included in the second cluster CLU2 is the same as the value of the second center point from the previous iteration; therefore, the second center point does not need to be updated.

The updated first center point “0.946”, the updated third center point “0.74” and the unchanged second center point “0.58” are used as three center points for the third iteration of clustering process, as shown in Table 4-1.

TABLE 4-1
Third iteration

| Center | First center | Second center | Third center |
|---|---|---|---|
| point | point | point | point |
| Value of | 0.946 | 0.58 | 0.74 |
| center point | | | |

Next, the clustering circuit 300 calculates the distances between the highest index scores F1_M(1) to F1_M(7) of the seven categories and the first center point “0.946”, the second center point “0.58” and the third center point “0.74”, as shown in Table 4-2. Furthermore, the clustering circuit 300 re-clusters the seven categories based on the distances between the highest index scores F1_M(1) to F1_M(7) and the three center points.

TABLE 4-2
Third iteration

| | | | Distance | | |
|---|---|---|---|---|---|
| | | Distance | from | Distance | |
| | Highest | from first | second | from third | |
| | index | center | center | center | |
| | score | point | point | point | Clustering |
| category | F1_M | “0.946 | “0.58” | “0.74” | results |
| first | 0.90 | 0.046 | 0.32 | 0.16 | first cluster |
| category | | | | | CLU1 |
| second | 0.94 | 0.006 | 0.36 | 0.2 | first cluster |
| category | | | | | CLU1 |
| third | 1.00 | 0.054 | 0.42 | 0.26 | first cluster |
| category | | | | | CLU1 |
| fourth | 0.72 | 0.226 | 0.14 | 0.02 | third cluster |
| category | | | | | CLU3 |
| fifth | 0.64 | 0.306 | 0.06 | 0.1 | second cluster |
| category | | | | | CLU2 |
| sixth | 0.76 | 0.186 | 0.18 | 0.02 | third cluster |
| category | | | | | CLU3 |
| seventh | 0.52 | 0.426 | 0.06 | 0.22 | second cluster |
| category | | | | | CLU2 |

Referring to both Tables 4-2 and 3-2, the clustering result of the third iteration is the same as that of the second iteration. In the clustering result of the third iteration, the first category “RV”, the second category “truck” and the third category “bus” are still clustered into the first cluster CLU1. The fifth category “rider” and the seventh category “bicycle” are still clustered into the second cluster CLU2. The fourth category “pedestrian” and the sixth category “motorcycle” are still clustered into the third cluster CLU3. Therefore, if a next iteration (i.e., the fourth iteration) is performed, the values of the first, second, and third center points will remain unchanged. This indicates that the clustering results of the third iteration have converged, and no further iteration is needed.

The clustering circuit 300 selects the two clusters with better detection performance from the first cluster CLU1, the second cluster CLU2 and the third cluster CLU3 in the converged clustering results. Since the index score F1 reflects the detection performance of the first computational model 100, the clustering circuit 300 selects the two clusters with higher index scores F1. For example, Table 4-2 shows that the highest index scores F1_M(1) “0.90”, F1_M(2) “0.94” and F1_M(3) “1.00” for the first, second and third categories of the first cluster CLU1 are relatively high; therefore, the clustering circuit 300 selects the first cluster CLU1. Furthermore, the highest index scores F1_M(4) “0.72” and F1_M(6) “0.76” for the fourth and sixth categories of the third cluster CLU3 are the second highest; therefore, the clustering circuit 300 also selects the third cluster CLU3.

On the other hand, the highest index scores F1_M(5) “0.64” and F1_M(7) “0.52” for the fifth and seventh categories of the second cluster CLU2 are relatively low; therefore, the clustering circuit 300 does not select the second cluster CLU2.

In the above embodiment, the seven categories of the object to be detected are divided into K clusters (e.g., K is equal to “3”), and then (K−1) clusters with higher highest index scores F1_M are selected from the K clusters, but this is not limited thereto. In other embodiments, (K−2) clusters or (K−3) clusters, etc., may also be selected. For example, when K is equal to “5”, four, three or two clusters with higher highest index scores F1_M may be selected.

Referring to FIG. 1 again, the first cluster CLU1 and the third cluster CLU3 selected by the clustering circuit 300 are transmitted to the normalization calculation circuit 400. The normalization calculation circuit 400 performs normalization calculations based on the first cluster CLU1 and the third cluster CLU3, so as to obtain an object amount ratio NR(i) and average area ratio AR(i) of the i-th category in the first cluster CLU1 and the third cluster CLU3.

The first cluster CLU1 and the third cluster CLU3 selected by the clustering circuit 300 include a total of five categories, which are: the first category “RV”, the second category “truck”, the third category “bus”, the fourth category “pedestrian” and the sixth category “motorcycle”. The object amount ratio NR(i) is defined as the ratio of the object amount N(i) in the validation set VD for the i-th category of the five categories with respect to the total object amount Nt of the five categories, as shown in equation (2-1):

$$NR ( i ) = \frac{N ( i )}{Nt} = \frac{N ( i )}{{Σ}_{i = 1 , 2 , 3 , 4 , 6} N ( i )} \qquad ( 2 - 1 )$$

For example, the first category includes 300 “RV” objects in the validation set VD, so the object amount N(1) in the first category is equal to 300. The second category includes 200 “truck” objects in the validation set VD, so the object amount N(2) in the second category is equal to 200. Similarly, the third, fourth and sixth categories respectively include 100 “bus” objects, 80 “pedestrian” objects and 50 “motorcycle” objects in the validation set VD. The object amounts N(3), N(4) and N(6) of the third, fourth and sixth categories are respectively equal to 100, 80 and 50. Furthermore, the total object amount Nt of the five categories is equal to the sum of the object amounts N(1), N(2), N(3), N(4) and N(6), which is equal to 730.

Based on equation (2-1), the normalization calculation circuit 400 utilizes a hardware divider circuit to calculate the following results: the object amount ratio NR (1) is 0.41 for the first category, the object amount ratio NR (2) is 0.27 for the second category, the object amount ratio NR (3) is 0.13 for the third category, the object amount ratio NR (4) is 0.11 for the fourth category, and the object amount ratio NR (6) is 0.06 for the sixth category.

On the other hand, the normalization calculation circuit 400 calculates the average area ratio AR(i) using a hardware image processor, an adder/subtractor circuit and divider circuit. Firstly, the normalization calculation circuit 400 analyzes the area occupied by a single object of the i-th category in the validation image M1 of the validation set VD, using the hardware image processor. Furthermore, the normalization calculation circuit 400 calculates the average of the areas in multiple validation images M1 for a single object of the i-th category, so as to obtain the average area A(i). Moreover, the normalization calculation circuit 400 calculates the ratio of the average area A(i) of the object in the i-th category with respect to the average area sum At of the objects in the five categories, so as to obtain the average area ratio AR(i) of the i-th category, as shown in equation (2-2):

$$AR ( i ) = \frac{A ( i )}{At} = \frac{A ( i )}{{Σ}_{i = 1 , 2 , 3 , 4 , 6} A ( i )} \qquad ( 2 - 2 )$$

For example, the “RV” object of the first category exists in 300 images in the validation set VD. A single “RV” object occupies an area of 10 cm² in the first image, occupies an area of 11 cm² in the second image, and occupies an area of 9 cm² in the third image, etc. The average area A(1) of the “RV” object of the first category is, for example, 9.5 cm². Similarly, the average area A(2) of the “truck” object in second category is, for example, 15 cm², the average area A(3) of the “bus” object in third category is, for example, 20 cm², the average area A(4) of the “pedestrian” object in fourth category four is, for example, 5 cm², and the average area A(6) of the “motorcycle” object in sixth category is, for example, 8 cm².

Based on the above average areas A(1), A(2), A(3), A(4) and A(6), the normalization calculation circuit 400 uses a hardware divider circuit to calculate the average area ratios AR (1), AR (2), AR (3), AR (4) and AR (6) of the objects in the first, second, third, fourth and sixth categories respectively, which are 0.16, 0.26, 0.34, 0.086, and 0.14, based on equation (2-2).

The normalization calculation circuit 400 transmits the object amount ratio NR(i) and average area ratio AR(i) of each category included in the selected first cluster CLU1 and third cluster CLU3 to the global calculation circuit 500. The global calculation circuit 500 calculates the global confidence threshold CT_G based on the object amount ratio NR(i) and average area ratio AR(i) of the five categories. More specifically, the global calculation circuit 500 firstly calculates the category weight w(i) of the i-th category based on the object amount ratio NR(i) and average area ratio AR(i), as shown in equation (3-1):

$$w ( i ) = w 1 \times NR ( i ) + w 2 \times AR ( i ) \qquad ( 3 - 1 )$$

The category weight w(i) is the weighted sum of the object amount ratio NR(i) and average area ratio AR(i) of the i-th category. In this calculation, the object amount ratio NR(i) is multiplied by a first weight w1, the average area ratio AR(i) is multiplied by a second weight w2, and the sum of the first weight w1 and the second weight w2 equals one. The first weight w1 can be a value of 0.6, and the second weight w2 can be a value of 0.4.

Then, the global calculation circuit 500 analyzes the confidence level CL(i) corresponding to the highest index score F1_M(i) of the i-th category included in the selected first cluster CLU1 and third cluster CLU3, as shown in Table 5. Furthermore, the global calculation circuit 500 sets the aforementioned confidence level CL(i) as the confidence threshold CT(i) for the i-th category. Therefore, the confidence threshold CT(1) for the first category is 0.633, the confidence threshold CT(2) for the second category is 0.877, the confidence threshold CT(3) for the third category is 0.177, the confidence threshold CT(4) for the fourth category is 0.595, and the confidence threshold CT(6) for the sixth category is 0.621.

TABLE 5

| | Category | | | | |
|---|---|---|---|---|---|
| | first | second | third | fourth | sixth |
| | cate- | cate- | cate- | cate- | cate- |
| | gory | gory | gory | gory | gory |
| Object | RV | Truck | Bus | Pedestrian | Motorcycle |
| Highest | 0.90 | 0.94 | 1.00 | 0.72 | 0.76 |
| index score | | | | | |
| F1_M | | | | | |
| Confidence | 0.633 | 0.877 | 0.177 | 0.595 | 0.621 |
| level CL | | | | | |

Then, the global computing circuit 500 calculates the weighted sum of the confidence thresholds CT(1), CT(2), CT(3), CT(4) and CT(6) for the five categories to obtain the global confidence threshold CT_G, as shown in equation (3-2). In the weighted sum of equation (3-2), the category weight w(i) of the i-th category shown in equation (3-1) is used as the weight of the confidence threshold CT(i) of the i-th category.

$$CT\_G = {Σ}_{i = 1 , 2 , 3 , 4 , 6} [ w ( i ) \times C T ( i ) ] \qquad ( 3 - 2 )$$

The global computing circuit 500 applies the global confidence threshold CT_G to the test set TS and tests the first computational model 100 based on the test set TS. The test set TS, after applying the global confidence threshold CT_G, can also be stored in the database 600.

In an inference stage of the first computational model 100, the first computational model 100 detects the objects to be detected in the actual field, so as to generate inference results. The detection device 1000 filters the inference results of the first computational model 100 based on a global confidence threshold CT_G, removing the results with confidence levels lower than the global confidence threshold CT_G.

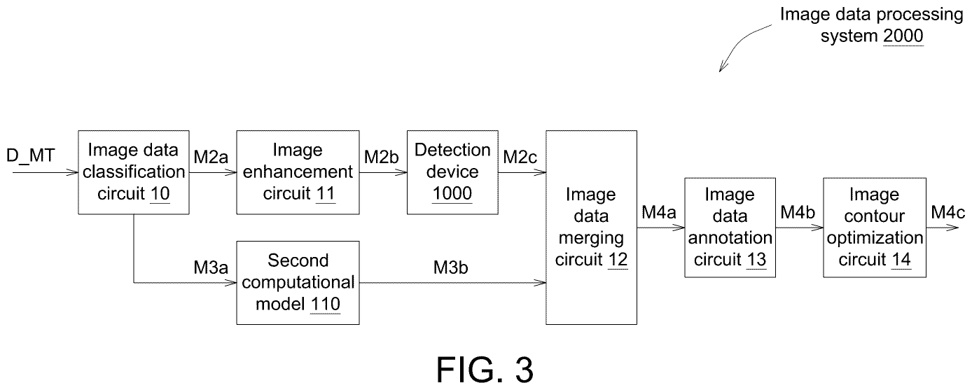

FIG. 3 is a schematic diagram showing the detection device 1000 of FIG. 1 applied to the image data processing system 2000. The image data processing system 2000 is used to process image data. The image data processing system 2000 can perform automatic annotation for image data. As shown in FIG. 3, the image data processing system 2000 includes an image data classification circuit 10, an image enhancement circuit 11, a second computational model 110, an image data merging circuit 12, an image data annotation circuit 13 and an image contour optimization circuit 14.

The image data classification circuit 10 receives image data metadata D_MT. The image data metadata D_MT is the original data of the image data to be processed. The image data classification circuit 10 classifies image data D_MT to generate a first original image M2a and a second original image M3a. The first original image M2a is, for example, an image taken at night, and the second original image M3a is, for example, an image taken during the day.

The second computational model 110 receives the second original image M3a from the image data classification circuit 10. The second computational model 110 detects the objects in the second original image M3a to generate a second detected image M3b.

Meanwhile, the image enhancement circuit 11 is electrically connected to the image data classification circuit 10 to receive the first original image M2a. The image enhancement circuit 11 performs image enhancement processing on the first original image M2a, so as to adjust parameters of low-light image data included in the first original image M2a, such as adjusting brightness and contrast. After performing image enhancement processing on the first original image M2a, the image enhancement circuit 11 generates a first enhanced image M2b.

A detection device 1000 is electrically connected to the image enhancement circuit 11 to receive the first enhanced image M2b. In the inference phase, the first computational model 100 of the detection device 1000 detects the objects in multiple categories in the first enhanced image M2b to generate inference results. More specifically, in the validation and testing phases prior to the inference phase of the first computational model 100, the detection device 1000 firstly calculates a global confidence threshold CT_G. Then, in the inference phase of the first computational model 100, the detection device 1000 filters the inference results for the objects in the first enhanced image M2b, removing results with confidence levels lower than the global confidence threshold CT_G from the inference results, thereby obtaining the first detected image M2c.

The image data merging circuit 12 is electrically connected to the detection device 1000 to receive the first detected image M2c, and communicatively connected to the second computational model 110 to receive the second detected image M3b. The image merging circuit 12 performs merging processing based on the first detected image M2c and the second detected image M3b, thereby merging the image data of daytime image with high-light and nighttime image with low-light. Based on the above merging processing, the image data merging circuit 12 generates a merged image M4a.

The image data annotation circuit 13 is electrically connected to the image data merging circuit 12 to receive the merged image M4a. The image data annotation circuit 13 annotates the merged image M4a to generate an annotated image M4b. In this embodiment, the first computational model 100 of the detection device 1000 is, for example, a “YOLOv10” model, which can more accurately select the image data of nighttime image with low-light in the first enhanced image M2b, so as to facilitate the image data annotation circuit 13 to annotate the objects in the merged image M4a.

The image contour optimization circuit 14 is electrically connected to the image data annotation circuit 13 to receive the annotated image M4b. The image contour optimization circuit 14 performs contour optimization processing (e.g., edge sharpening processing) on the annotated objects in the annotation image M4b, thereby optimizing and highlighting the contours of the annotated objects. Based on the above contour optimization processing, the image contour optimization circuit 14 generates an optimized image M4c.

Based on the above embodiments, the function of automatic image data annotation performed by the image data processing system 2000 can improve the accuracy of image data annotation, and reduce the time cost of manual fine-tuning.

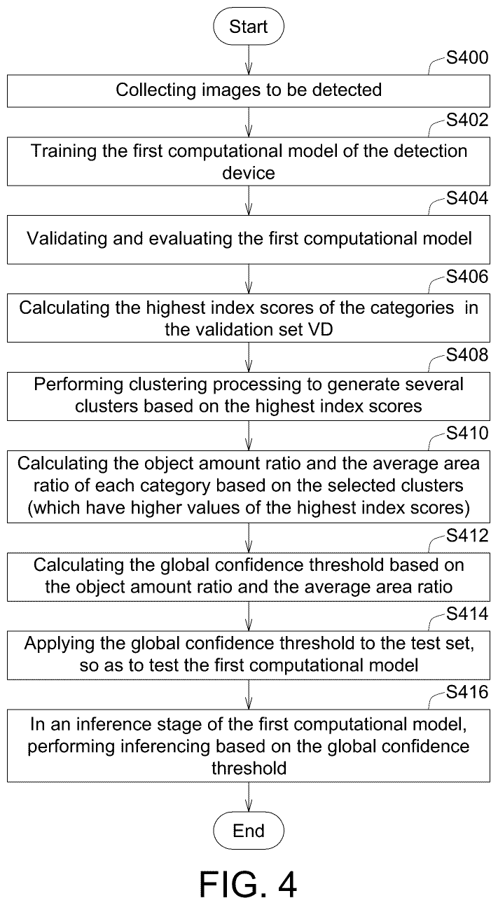

FIG. 4 is a flowchart of a detection method according to an embodiment of the present disclosure. The detection method is used for object detection and can be implemented by the detection device 1000 of FIG. 1. As shown in FIG. 4, step S400 is firstly performed: collecting images to be detected. For example, a camera device in the form of hardware circuitry which is installed on a mobile vehicle may perform image capturing on multiple objects to be detected in the surrounding environment, so as to obtain images including these objects. The collected images which are under detection, can be used to establish a training set TS and a validation set VD for the first computational model 100.

Next, step S402 is performed: the first computational model 100 of the detection device 1000 is trained. For example, the first computational model 100 is trained using images included in the training set TS stored in the database 600.

Next, step S404 is performed: the first computational model 100 is validated and evaluated. For example, the first computational model 100 is validated using validation images M1 included in the validation set VD stored in the database 600.

Next, step S406 is performed: the highest index scores F1_M of the categories (e.g., seven categories) in the validation set VD are calculated. For example, the index analysis circuit 200 of the detection device 1000 performs a “grid search” on the data sequences DS(1) to DS(7) of the first to seventh categories in the validation set VD, so as to obtain the highest index scores F1_M(1) to F1_M(7) of the above seven categories.

Next, step S408 is performed: based on the highest index scores F1_M(1) to F1_M(7) of the seven categories, clustering processing is performed on the seven categories. For example, the clustering circuit 300 of the detection device 1000 performs “K-means” clustering based on the highest index scores F1_M(1) to F1_M(7), so as to divide the seven categories into K clusters. When K is, for example, equal to “3”, the categories can be clustered into the first cluster CLU1, the second cluster CLU2, and the third cluster CLU3. Furthermore, the clusters which have higher values of the highest index scores F1_M among the first cluster CLU1, the second cluster CLU2 and the third cluster CLU3 are selected. For example, the first cluster CLU1 and the third cluster CLU3 are selected.

Next, step S410 is executed: the object amount ratio NR(i) and the average area ratio AR(i) are calculated based on the first cluster CLU1 and the third cluster CLU3 which have higher values of the highest index scores F1_M. For example, the normalization calculation circuit 400 of the detection device 1000 calculates the object amount ratio NR(i) and the average area ratio AR(i) of the i-th category (“i” is, e.g., equal to 1, 2, 3, 4 and 6) of the selected first cluster CLU1 and third cluster CLU3.

Next, step S412 is executed: the global confidence threshold CT_G is calculated based on the object amount ratio NR(i) and the average area ratio AR(i) of the selected category. For example, the global calculation circuit 500 of the detection device 1000 calculates the category weight w(i) of the i-th category based on the object amount ratio NR(i) and the average area ratio AR(i), and then uses the category weight w(i) as the weight of the confidence threshold CT(i) of the i-th category for weighted calculation, so as to obtain the global confidence threshold CT_G.

Next, step S414 is executed: the global confidence threshold CT_G is applied to the test set TS, and the first computational model 100 is tested based on the test set TS.

Next, step S416 is executed: in the inference stage of the first computational model 100, the inference results of the first computational model 100 are filtered based on the global confidence threshold CT_G. For example, results with confidence levels lower than the global confidence threshold CT_G are filtered out from the inference results, so as to exclude results with poor detection performance.

Based on the above embodiments, the detection device 1000 and detection method of the present disclosure are based on an “Adaptive Confidence Threshold” mechanism, which can systematically and automatically calculate confidence thresholds applicable to various types of objects, thereby improving the detection performance of the first computational model 100.

Furthermore, the present invention further discloses a non-volatile computer-readable storage medium, which is applied to a computing device or a computer having a processor (e.g., CPU, GPU, etc.) and/or a memory, which stores instructions. The computing device or computer executes the instruction codes stored in the non-volatile computer-readable storage medium through the processor and/or memory, so as to perform the aforementioned methods and steps when executing the non-volatile computer-readable storage medium. In one embodiment, the present invention discloses a non-transitory computer-readable storage medium to perform the aforementioned methods and steps.

In conventional setting mechanism for the confidence thresholds, if the number of objects of certain classifications is small, the computational model will have bias, resulting in a reduction in the effectiveness of the confidence threshold. In contrast, the detection device 1000 and detection method of the present disclosure can overcome the aforementioned technical problems of conventional setting mechanism for the confidence thresholds. The detection device 1000 and detection method disclosed herein calculate the average of the highest index score F1_M using a “chi-squared fitting” algorithm, and exclude categories with poor detection performance through the clustering mechanism. Furthermore, based on the statistical results of each category in the validation set, different weights are assigned to each selected category. Therefore, the importance of different information can be considered, thereby optimizing the setting of the confidence threshold and significantly improving the detection performance of the first computational model 100.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A detection device, for object detection in an image data processing system, the detection device comprising:
a first computational model, for detecting a plurality of objects in a validation set during a validation phase to generate a detection result, wherein the objects have a plurality of categories;
an index analysis circuit, communicatively connected to the first computational model, for analyzing the detection result of the first computational model to generate a highest index score for each of the categories;
a clustering circuit, electrically connected to the index analysis circuit, for clustering the categories into a plurality of clusters of a first number based on the highest index scores of the categories, and selecting a plurality of clusters of a second number from the first number of clusters;
a normalization calculation circuit, electrically connected to the clustering circuit, for performing a normalization calculation to obtain an object amount ratio and an average area ratio of each of the categories in the second number of clusters; and
a global calculation circuit, electrically connected to the normalization calculation circuit, for calculating a global confidence threshold based on the object amount ratio and the average area ratio of each of the categories,
wherein, the first computational model receives a plurality of first images from an image data metadata of the image data processing system, detects the objects in the first images in an inference stage to generate an inference result, and filters the inference result based on the global confidence threshold.

2. The detection device of claim 1, wherein the index analysis circuit analyzes the detection result to generate a confusion matrix, calculates a precision index and a recall index based on the confusion matrix, and calculates an index score of each of the categories based on the precision index and the recall index.

3. The detection device of claim 2, wherein the index analysis circuit performs a grid search based on the index scores of the categories to obtain the highest index scores of the categories.

4. The detection device of claim 1, wherein the clustering circuit calculates a plurality of distances between the highest index scores of the categories and a plurality of center points of the first number, and clusters the categories into the first number of clusters based on the distances.

5. The detection device of claim 4, wherein the clustering circuit calculates an average of the highest index scores of the categories included in each of the clusters of the first number, and updates the center point corresponding to the cluster based on the average.

6. The detection device of claim 1, wherein the global calculation circuit calculates the global confidence threshold based on a confidence threshold and a category weight for each of the categories in the second number of clusters.

7. The detection device of claim 6, wherein the confidence threshold is equal to a confidence level corresponding to the highest index score of each of the categories in the second number of clusters.

8. The detection device of claim 6, wherein the category weight is equal to a weighted sum of the object amount ratio and the average area ratio.

9. The detection device of claim 1, wherein the normalization calculation circuit calculates an object amount in the validation set for each of the categories of the second number of clusters, and calculates a ratio of the object amount with respect to a total object amount of the categories to obtain the object amount ratio.

10. The detection device of claim 1, wherein the normalization calculation circuit calculates an average area of each of the objects of each of the categories in the second number of clusters in a plurality of validation images in the validation set, and calculates a ratio of the average area with respect to an average area sum of the categories to obtain the average area ratio.

11. A detection method, for object detection in an image data processing system, the detection method comprising:
in a validation stage of a first computational model, detecting a plurality of objects in a validation set by the first computational model to generate a detection result, wherein the objects have a plurality of categories;
analyzing the detection result of the first computational model to generate a highest index score of each of the categories;
clustering the categories into a plurality of clusters of a first number based on the highest index scores of the categories;
selecting a plurality of clusters of a second number from the first number of clusters;
performing a normalization calculation to obtain an object amount ratio and an average area ratio of each of the categories in the second number of clusters;
calculating a global confidence threshold based on the object amount ratio and the average area ratio of each of the categories;
receiving a plurality of first images form an image data metadata of the image data processing system by the first computational model;
in an inference phase of the first computational model, detecting the objects in the first images to generate an inference result, by the first computational model; and
filtering the inference result based on the global confidence threshold.

12. The detection method of claim 11, wherein the step of generating the highest index scores comprising:
analyzing the detection result to generate a confusion matrix;
calculating a precision index and a recall index based on the confusion matrix; and
calculating an index score of each of the categories based on the precision index and the recall index.

13. The detection method of claim 12 further comprising:
performing a grid search based on the index scores of the categories to obtain the highest index scores of the categories.

14. The detection method of claim 11, wherein the step of clustering the categories into the first number of clusters comprising:
calculating a plurality of distances between the highest index scores of the categories and a plurality of center points of the first number; and
clustering the categories into the first number of clusters based on the distances.

15. The detection method of claim 14 further comprising:
calculating an average of the highest index scores of the categories included in each of the clusters of the first number; and
updating the center point corresponding to the cluster based on the average.

16. The detection method of claim 11, wherein the step of calculating the global confidence threshold comprising:
analyzing a confidence threshold of each of the categories in the second number of clusters;
calculating a category weight for each of the categories in the second number of clusters; and
calculating the global confidence threshold based on the confidence threshold and the category weight.

17. The detection method of claim 16, wherein the confidence threshold is equal to a confidence level corresponding to the highest index score of each of the categories in the second number of clusters.

18. The detection method of claim 16, wherein the category weight is equal to a weighted sum of the object amount ratio and the average area ratio.

19. The detection method of claim 11, wherein the step of performing the normalization calculation to obtain the object amount ratio comprising:
calculating an object amount in the validation set for each of the categories of the second number of clusters; and
calculating a ratio of the object amount with respect to a total object amount of the categories to obtain the object amount ratio.

20. The detection method of claim 11, wherein the step of performing the normalization calculation to obtain the average area ratio comprising:
calculating an average area of each of the objects of each of the categories in the second number of clusters in a plurality of validation images in the validation set; and
calculating a ratio of the average area with respect to an average area sum of the categories to obtain the average area ratio.

21. A non-volatile computer-readable storage medium, applied to a computing device or a computer and storing instructions, for performing the detection method of claim 11.
